(19) United States
(12) Patent Application Publication
(10) Pub. No.: US 2019/0257930 A1
(43) Pub. Date: Aug. 22, 2019

(54) MULTI FREQUENCY PISTON TRANSDUCER

(71) Applicant: Rowe Technologies, Inc., Poway, CA (US)

(72) Inventors: Sairajan Sarangapani, Poway, CA (US); Francis Dale Rowe, Poway, CA (US)

(21) Appl. No.: 16/131,970

(22) Filed: Sep. 14, 2018

Related U.S. Application Data
(60) Provisional application No. 62/633,468, filed on Feb. 21, 2018.

(51) Int. Cl. G01S 7/521; G01S 15/58

(52) U.S. Cl. CPC G01S 7/521; G01S 15/586

(57) ABSTRACT

Multi frequency piston transducers which are capable of simultaneously or sequentially forming multiple overlaid acoustic beams. In one implementation, a dual frequency piston transducer is disclosed which is capable of simultaneously or sequentially forming two overlaid acoustic beams. The transducer consists of two or more electrically and acoustically independent piston transducers operating at different frequencies that are physically integrated into a single multi-frequency configuration. This single multi-frequency configuration consists of a high frequency aperture disposed within the aperture area of a lower frequency piston transducer. Additionally, multiple dual frequency piston transducers that are incorporated within a single housing are also disclosed that are useful in, for example, ADCP and measurement of vessel/ship speed applications. Methods of manufacturing and using the aforementioned multi frequency piston transducers are also disclosed.

### PRIORITY

This application claims the benefit of priority to co-owned and co-pending U.S. Provisional Application Ser. No. 62/633,468 of the same title filed Feb. 21, 2018, the contents of which being incorporated herein by reference in its entirety.

### CROSS-REFERENCE TO RELATED APPLICATIONS

This application is related to co-owned U.S. patent application Ser. No. 13/282,257 filed Oct. 26, 2011 entitled “Multi Frequency 2D Phased Array Transducer”, which claims the benefit of priority to U.S. Provisional Patent Application Ser. No. 61/456,086 filed Nov. 1, 2010 of the same title, each of which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates generally to a sonar transducer and in one exemplary aspect to a narrow beam multi-frequency piston sonar transducer for measuring underwater current as a function of depth, for example, an Acoustic Doppler Current Profiler (ADCP) system.

### DESCRIPTION OF RELATED TECHNOLOGY

Underwater sonar transducers are widely used in different types of acoustic backscatter systems to measure velocity and/or distance along narrow acoustic beams. A class of these sonars employs a single disk transducer where the piston transducer produces a single acoustic radiating beam normal to the transducer face. One such exemplary prior art piston transducer 100 is illustrated in FIG. 1 which includes a single radiating face 102. These piston transducers 100 may be utilized by themselves, or may be utilized in combination with other similar types of piston transducers in, for example, so-called ADCP (Acoustic Doppler Current Profiler) applications. ADCP systems may operate from, for example, a surface vessel, where it is often times desirable to measure current profiles throughout a given water column. However, the region of the water column near the surface is often more spatially, temporally and has more dynamic fluctuations in velocity than deeper water columns. Accordingly, it may be desirable to measure the shallower, near transducer region with a higher spatial, temporal and velocity resolution than the deeper longer range region. For this class of ADCP sonar applications with the near dynamic and deeper less dynamic water motion, these ADCP sonar systems are currently achieved by operating with either: (1) two separate and distinct piston-type (“disc”) ADCP sonars in two four-beam sets, with each set typically separated in frequency by an approximate factor of four; or (2) dual frequency 2D phased array transducers such as that disclosed in co-owned U.S. patent application Ser. No. 13/282,257 filed Oct. 26, 2011 entitled “Multi Frequency 2D Phased Array Transducer”, which claims the benefit of priority to U.S. Provisional Patent Application Ser. No. 61/456,086 filed Nov. 1, 2010 of the same title, each of the foregoing being incorporated herein by reference in its entirety supra.

However, such prior techniques are limited in that: (1) the bandwidth at each operating frequency is limited to about six percent (6%); (2) the phased array transducers disclosed in the above-referenced ADCP application are more expensive to manufacture than the aforementioned four-piston sets; (3) they are not useable in subsurface mooring application where a mooring cable in disposed in front of the transducer due as a result of near field beamforming requirements in front of the transducer; and (4) are not usable for deep ocean deployments due to lower pressure ratings of the multi-element arrays. Accordingly, transducer apparatus are desired that address the foregoing concerns.

### SUMMARY

The present disclosure addresses the foregoing needs by providing improved transducer apparatus and methods of manufacture and use.

In one aspect, a broadband electroacoustic transducer for producing sound in a fluid medium is disclosed. In one embodiment, the broadband electroacoustic transducer includes a plurality of disk transducer elements, each having different fundamental resonance frequencies with each fundamental resonance frequency having an independent surface area and the different fundamental frequencies being a result of differing dimensions between each of the plurality of disk transducer elements and/or each of the plurality of disk transducer elements having different backing and/or front layers in order to produce surface vibrations to form independent beams in the far field. The two transducers are embodied within the area of a single frequency transducer and the radiating surfaces for these two transducers are independent of one another.

In one variant, the plurality of disk transducer elements includes a first disk transducer element and a second disk transducer element, where the second disk transducer element is positioned within a first aperture of the first disk transducer element and the second disk transducer element operating at a resonant frequency that is higher than the first disk transducer element so that the first disk transducer element and the second disk transducer element having an identical, or near identical, beam width in the far field. The two transducers can be configured and may be operated independent of each other.

In yet another variant, the first disk transducer element and the second disk transducer element each include a bandwidth of approximately 50%, the bandwidth being 25% above and 25% below the respective fundamental resonant frequencies of the first disk transducer element and the second disk transducer element.

In yet another variant, the plurality of disk transducer elements may be operated at a same resonant frequency in an alternative operating mode such as in narrow band or broad band mode in ADCP application.

In yet another variant, the plurality of disk transducer elements are aligned axisymmetrically with a height-to-radius aspect ratio less than unity in order to produce acoustic radiation along the direction of the axis of symmetry and simultaneously in the direction perpendicular to the axis of symmetry.

In yet another variant, the plurality of disk transducer elements are encapsulated in a cup made of metal or plastic that permits acoustical radiation based on excitation of the respective fundamental resonance frequency of a respective piezoelement.

In yet another variant, the second disk transducer element is ¼ of the thickness of the first disk transducer element, the thickness difference contributing to the identical, or near identical, beam width.

In yet another variant, the plurality of disk transducer elements are connected electrically to a transmitting device to realize operation as an acoustic source or acoustic receiver, capable of measuring water currents underwater, detecting depth of a given water column, and measuring backscattering signal strength to detect objects underwater.

In yet another variant, the second disk transducer element may be used for measuring underwater water flow speed and direction in shallow water or at close range to the electroacoustic transducer and the first disk transducer element may be used for measuring underwater water flow speed and direction at ranges farther away from the electroacoustic transducer.

In yet another variant, the plurality of disk transducer elements may operate at depths close to a surface of the fluid medium and may also be deployed deeper of at depths of at least 2000 m.

In yet another variant, each disk transducer element of the plurality of disk transducer elements may collectively operate in a frequency range that varies from 50 kHz to 3 MHz and operated at a local bandwidth of about 25% of the resonant frequency of operation.

In yet another variant, the plurality of disk transducer elements may collectively be used as a high power device with half passive materials.

In yet another variant, the first transducer consists of a flat faced piston with an open central portion, and the second transducer array is located within this central portion as shown in FIG. 2.

In yet another aspect of the disclosure, a multi-frequency transducer assembly for use in an Acoustic Doppler Current Profiler (ADCP) application is disclosed. In one embodiment, the multi-frequency transducer array includes a single transducer assembly structure having a first transducer set optimized for operation over a long current profiling range, and a second transducer set optimized for operation over a shorter range with significantly higher spatial, temporal spatial resolution.

In yet another aspect of the disclosure, methods of manufacturing or using any of the aforementioned transducer assemblies are disclosed.

These and other aspects of the disclosure shall become apparent when considered in light of the disclosure provided herein.

### BRIEF DESCRIPTION OF THE DRAWINGS

The features, objectives, and advantages of the disclosure will become more apparent from the detailed description set forth below when taken in conjunction with the drawings, wherein:

FIG. 1 is a perspective view of a prior art single frequency piston transducer, in accordance with the principles of the present disclosure.

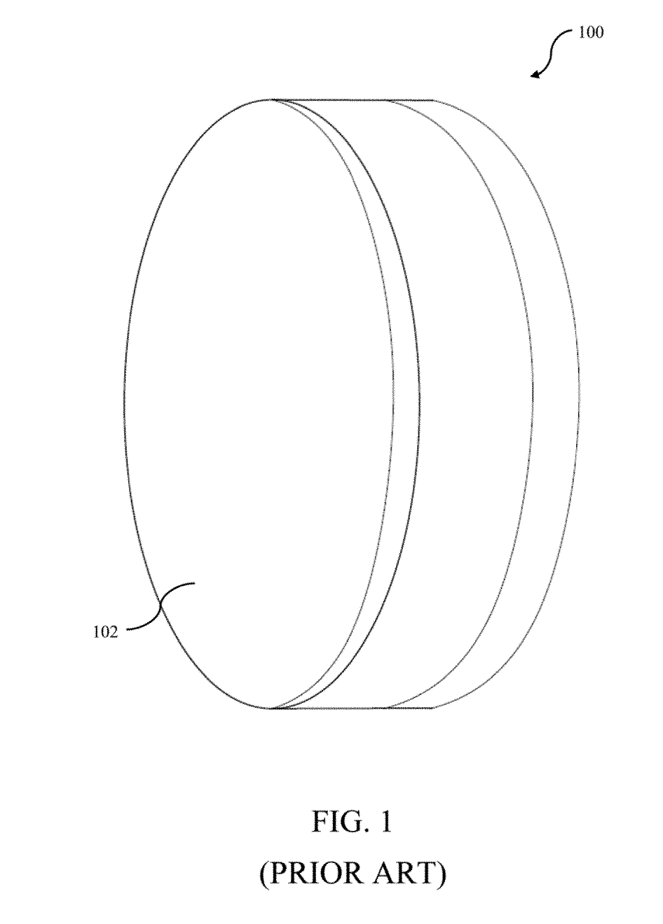

FIG. 2 is a perspective view of one exemplary implementation of a dual frequency piston transducer, in accordance with the principles of the present disclosure.

FIG. 3 is a perspective view of the exemplary dual frequency piston transducer of FIG. 2, illustrating the beams generated in accordance with the principles of the present disclosure.

FIG. 4 illustrates a cross sectional view of the dual frequency piston transducer of FIG. 2, in accordance with the principles of the present disclosure.

FIG. 5 is a perspective view of a transducer set of four (4) dual frequency piston transducers as shown in FIG. 2 where each piston transducer operates in two (2) acoustic frequencies, in accordance with the principles of the present disclosure.

FIG. 5A is a plan view of a transducer set of four (4) dual frequency piston transducers as shown in FIG. 2 where each piston transducer operates in two (2) acoustic frequencies, in accordance with the principles of the present disclosure.

FIG. 6 is a plot of measured transmit voltage response for one of the two transducers of the dual frequency piston transducer of FIG. 2 that operates at 300 kHz in accordance with the principles of the present disclosure.

FIG. 7 is a plot of measured transmit voltage response for the other one of the two transducers of the dual frequency piston transducer of FIG. 2 that operates at 1,200 kHz in accordance with the principles of the present disclosure.

FIG. 8 is a beam pattern plot for one of the two transducers of the dual frequency piston transducer of FIG. 2 that operates at 300 kHz in accordance with the principles of the present disclosure.

FIG. 9 is a beam pattern plot for the other one of the two transducers of the dual frequency piston transducer of FIG. 2 that operates at 1,200 kHz in accordance with the principles of the present disclosure.

FIG. 10 is a screen shot illustrating various measurement data for the dual frequency piston transducer of FIG. 2, in accordance with the principles of the present disclosure.

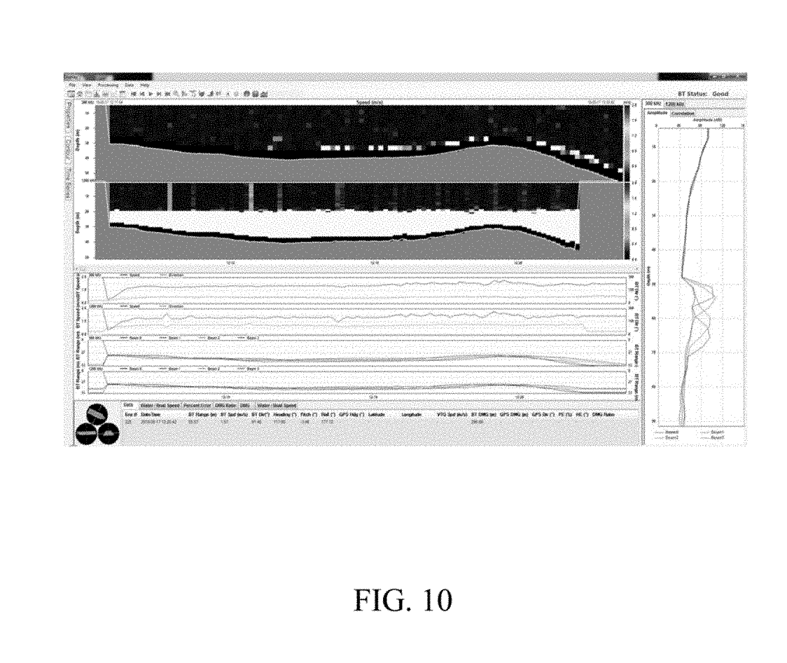

All Figures disclosed herein are © Copyright 2018 Rowe Technologies, Inc. All rights reserved.

### DETAILED DESCRIPTION OF THE PREFERRED EMBODIMENT

Reference is now made to the drawings wherein like numerals refer to like parts throughout.

### Overview

The present disclosure provides, inter alia, a dual frequency piston transducer which is capable of simultaneously or sequentially forming two overlaying acoustic beams. The transducer consists of two or more electrically and acoustically independent piston transducers operating at different frequencies that are physically integrated into a single multi-frequency configuration. This single multi-frequency configuration consists of a high frequency aperture located within the aperture area of a lower frequency piston transducer. Additionally, multiple dual frequency piston transducers that are incorporated within a single housing are also disclosed and contemplated for use in, for example, ADCP applications.

### Detailed Description of Exemplary Embodiments

Detailed descriptions of the various embodiments and variants of the apparatus and methods of the disclosure are now provided. While primarily discussed in the context of Acoustic Doppler Current Profiler (ADCP) applications, the various apparatus and methodologies discussed herein are not so limited. In fact, many of the apparatus and methodologies described herein are useful in sonar applications where diverse operating frequencies are advantageous, and where multiple transducer apertures are also important. For example, the dual frequency piston transducer apparatus disclosed herein may be utilized in determining zooplankton size and distribution, fish finders, Doppler velocity logs used for navigation and other suitable types of sonar applications.

Furthermore, while primarily discussed in the context of a dual frequency piston transducer having two distinct transducer surfaces, it is appreciated that additional transducer surfaces (i.e. three (3) or more) could be embodied within a piston transducer in accordance with embodiments of the present disclosure as described elsewhere herein. In addition, certain features discussed with respect to specific implementations can, in many instances, be readily adapted for use in one or more other contemplated implementations that are described herein. It can be readily recognized by one of ordinary skill, given the present disclosure that many of the features described herein possess broader usefulness outside of the specific examples and implementations with which they are described.

### Multiple Frequency Piston Transducers

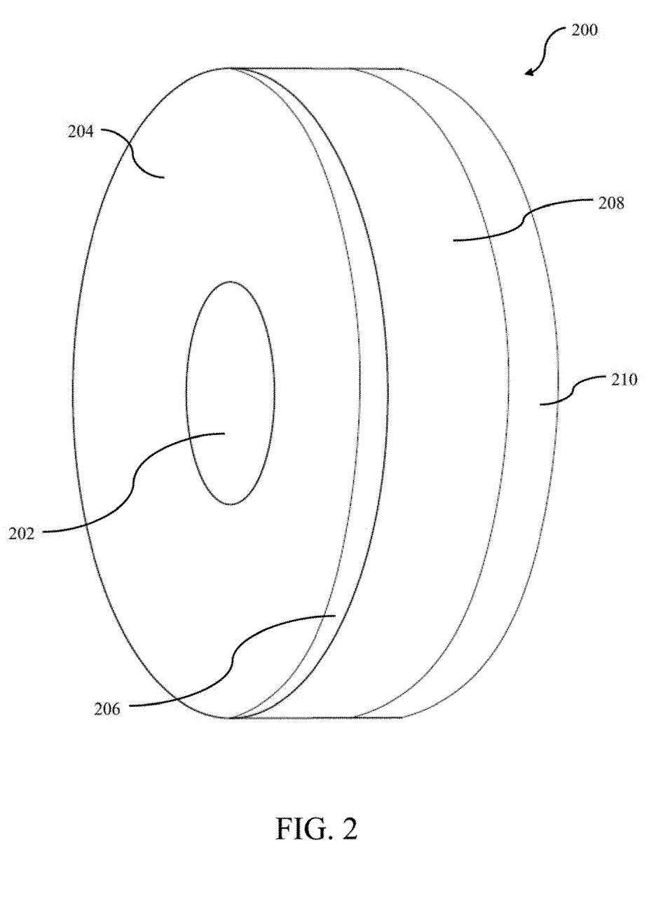

Referring now to FIG. 2, an exemplary dual frequency piston transducer 200 is shown and described in detail. The dual frequency piston transducer 200 may be coupled with electronic circuitry in order to realize operation as an acoustic source and/or as an acoustic receiver that is capable of measuring, inter alia, speed of water currents, depths of a given water column, as well as for the detection of underwater objects. In other words, the dual frequency piston transducer 200 disclosed herein may transmit acoustic waves and measure the volume or surface backscattering signal strength in order to determine, for example, the depth of a given water column. The dual frequency piston transducer may include two (2) physically distinct and independent disk transducer elements (or faces) 202, 204 that may operate at two (2) distinct operating frequencies. The inner transducer element 202 may include a circular face, while the outer transducer element 204 may include a “donut” shaped face. In some implementations, the high frequency transducer element 202 may be sized so as to have a different fundamental resonant frequency from the low frequency transducer element 204. In other words, one of the transducer elements may be used for measuring backscattering strength at, for example, shallow depths (e.g., at or around 10 cm and above) that are closer to the transducer face 202, while the other transducer element may be used for measuring backscattering strength at depths that are farther away (e.g., at or around 350 m) from the transducer face 204.

For example, transducer element 202 may operate at a fundamental resonant frequency of approximately twelve hundred (1,200) kHz, while transducer element 204 may operate at a fundamental resonant frequency of approximately three hundred (300) kHz. This factor of four separation in frequencies is chosen mainly due to the collective difference in backscattering strength for the two different frequencies (i.e., measurements collected from each of these frequencies are differentiable from the other frequency, etc.). However, it would be readily apparent to one of ordinary skill given the contents of the present disclosure that the aforementioned frequencies of operation are merely exemplary and could be readily modified to have other fundamental resonant frequencies in alternative variants. For example, it would be reasonable for each of the transducer faces to operate at frequencies that may vary between approximately fifty (50) kHz and three (3) MHz (or any operating frequency lying there between). Moreover, due to the nature of the construction of the dual frequency piston transducer 200, this transducer may operate at depths closer to the surface of the fluid medium, as well as at greater depths of approximately two-thousand meters (2,000 m). In some implementations, the distinct and independent disk transducer elements 202, 204 may be configured to operate at the same (identical or near identical) frequency range. Such identical or near identical range may be useful dependent upon the surface area to be measured, the range of measurement and/or the volume coverage underwater.

In some implementations, the transducer elements 202, 204 may consist of separate electro-acoustic transducer elements which may be sized so as to have differing fundamental resonance frequencies. These transducer elements 202, 204 may be aligned axisymmetrically with a height-to-radius aspect ratio less than unity in order to produce acoustic radiation along the direction of the axis of symmetry. The electro-acoustic (or electro-mechanical) transducer elements 202, 204 may also be used as high power devices that utilize half passive materials. As is understood by one of ordinary skill, half passive materials need not necessarily be connected directly to the voltage source that drives the transducer, although these types of materials are useful for the vibrations that they produce. The fundamental resonant frequencies for each of these transducer elements 202, 204 may be dependent on both the diameter of the transducer element 202, 204 as well as the depth (thickness) of various materials used in respective transducer elements 202, 204. For example, using the aforementioned operating example of twelve hundred (1,200) kHz and three hundred (300) kHz, the diameter of these transducer elements 202, 204 may be equivalent to ten (10) wavelengths of the fundamental resonant frequencies wide. Furthermore, using the aforementioned example, the diameter of transducer element 204 will be approximately four (4) times larger than the diameter of transducer element 202.

In some implementations, the two (or more) distinct transducer elements 202, 204 may be used independently from one another. In other words, simultaneous operation of both transducer elements 202, 204 may not be required at all times, and independent operation of the transducer elements 202, 204 may be advantageous in certain applications. For example, should a user wish to detect the surface at a depth of around 500 m, the low frequency transducer may only be used. However, as the user moves towards the shore (e.g., on a vessel or ship), the operation of the dual frequency piston transducer 200 may switch to the high frequency transducer from the low frequency transducer as the depth becomes shallower. This allows for a variety of applications to be utilized in a single dual frequency piston transducer 200. The dual frequency piston transducer 200 may also be used for echo characterization, river discharge and sediment measurement and the like. Such usage scenarios are highly useful as prior devices required two separate systems with two different frequencies in order to make measurements for such applications. In other words, the dual frequency piston transducer 200 has the benefit of providing these types of measurement in one system that is more efficient in terms of space, use and handling.

The dual frequency piston transducer 200 shown in FIG. 2 may consist of a plurality of layers resulting in a so-called half-passive stack. For example, layer 206 may consist of piezoelectric ceramic disks; while layer 208 may consist of a low impedance backing material (detailed in later section); and layer 210 may consist of a high impedance material (e.g., Aluminum). The low impedance backing material layer 208 may consist of glass sphere syntactic foam made by using a high-performance epoxy. In some implementations, the backing material may be made from any suitable low impedance material including, for example, Corprene, urethane and the like. The high impedance material layer 210 provides, inter alfa, a perfect boundary condition for the radiation of beams underwater. The piezoelectric ceramic layer 206 may be the only active material in the stack. In some implementations, layer 206 may be covered with a front layer material (see, e.g., matching material 216, FIGS. 2A, 2B). The front layer material helps to radiate the sound from the piezoceramic into the water effectively over a broader frequency range.

As but another example, layers 210l, 210h may consist of a baffle material such as a so-called Syntactic Acoustic Damping Material (SADM). The use of SADM (and other suitable baffle materials) may operate to act as an acoustic baffle which causes the transducer 200 to radiate energy to the front of the transducer surface, while minimizing/eliminating radiation in other directions. In addition, the use of SADM isolates the dual frequency piston transducer 200 from the structure to which it is installed. These baffle materials may be chosen such that they are lightweight, yet provide high acoustic isolation. As previously alluded to above, the construction of these dual frequency transducers 200 may also allow for operation at increased depths as compared with, for example, the dual frequency phased array described in co-owned U.S. patent application Ser. No. 13/282,257 filed Oct. 26, 2011 entitled “Multi Frequency 2D Phased Array Transducer”, the contents of which were previously incorporated supra. For example, the aforementioned multi frequency 2D phased array transducer includes dicing for the transducer elements which limits its ability to be deployed at greater depths. While techniques exist that permit these phased array transducers to operate at greater depths, the manufacturing cost of deploying these phased array transducers at greater depths can be an order of magnitude (or more) higher from the dual frequency piston transducer 200 described herein.

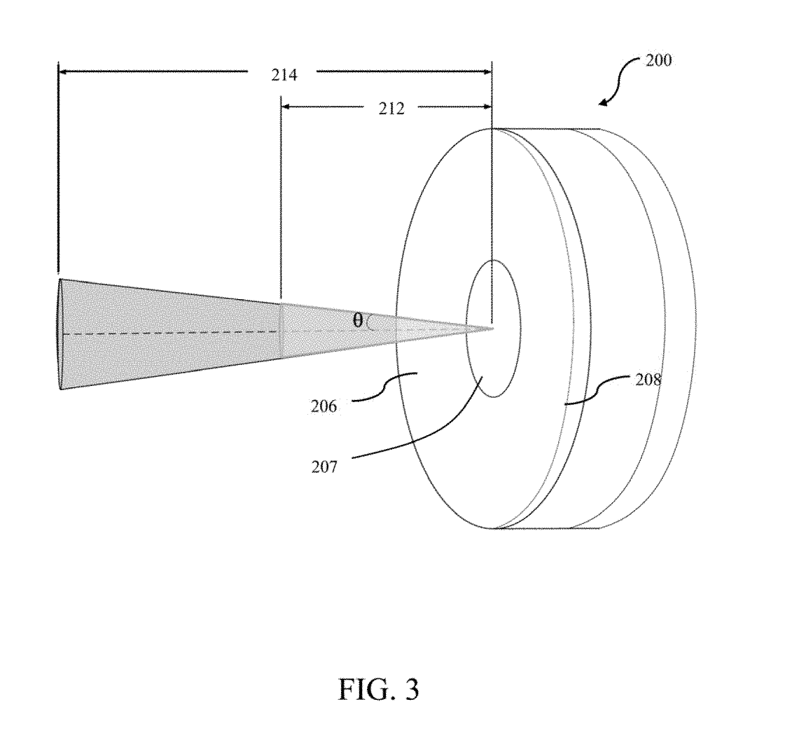

Referring now to FIG. 3, operation of the dual frequency piston transducer 200 may result in the transmission (and/or reception) of beams formed by the respective transducer elements 202, 204. For example, operation at the lower frequency provides greater sonar range 214 (e.g., for use at deeper water column depths), but may have less spatial, velocity, and temporal resolution. Conversely, operation at a higher frequency has less range 212, but may provide better spatial, velocity and temporal resolution over that respective range. The respective ranges 212, 214 may be dependent upon the conditions of the fluid medium (e.g., water) as well as the resonant frequency of the generated beams. Ideally, both of the generated beams 212, 214 will have an identical (or near identical) beam width θ. For example, inclusion of apertures within one or more of the transducer elements may be used to shape the width of the beam (i.e., beam width θ). Identical (or near identical) beam widths may be important as errors related to measurements obtained will be diminished. Additionally, the volume that is insonified underwater by the beams will be the same, or similar, thereby permitting a comparison of the backscattered scattering strength measured due to the different transmitted frequencies. Such identical (or near identical) beamwidths between the transducers may be useful for broadband ambiguity resolution, increase in range due to low frequency operation and increase in resolution due to high frequency operation. Additionally, more useful information may be obtained from amplitude backscatter measurements as well as from sound velocity profiles

The generated beams may also have a relatively narrow beam width θ, which may be dependent upon the frequency of operation. For example, using the aforementioned operating example of twelve hundred (1,200) kHz and three hundred (300) kHz, the value of θ may be equivalent to approximately one and a half degrees (1.5°). The transducer is limited to about twenty-five percent (25%) above or twenty-five percent (25%) below a nominal operating frequency. Contrast with the bandwidth described in co-owned U.S. patent application Ser. No. 13/282,257 filed Oct. 26, 2011 entitled “Multi Frequency 2D Phased Array Transducer”, the contents of which were incorporated supra, which may be limited to about six percent (6%).

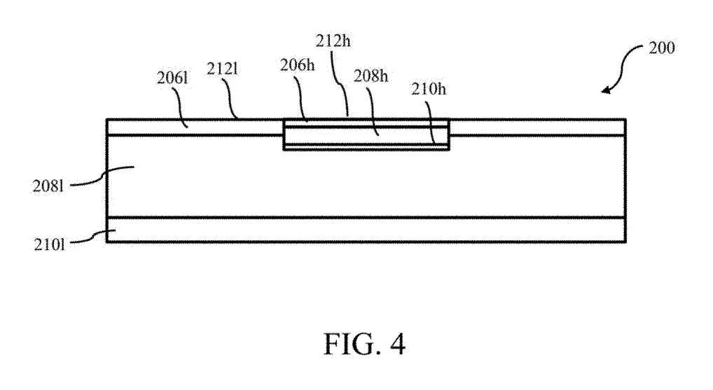

FIG. 4 illustrates the various components utilized within the low frequency transducer in accordance with some implementations. Specifically, the low frequency transducer includes a piezoelectric ceramic layer 206l, a low impedance backing material layer 208l, a high impedance backing material layer 210l and a matching material layer 216l. Note also that the piezoelectric ceramic layer 206l has a pair of wires 218l that are connected thereto. The pair of wires 218l is coupled to electronic circuitry (not shown) that is configured to generate (and/or receive) the beams for the low frequency transducer. The electronic circuitry may further be configured to operate the transducer elements simultaneously or independently. FIG. 4 illustrates the various components utilized within the high frequency transducer in accordance with some implementation. Similar to the low frequency transducer, the high frequency transducer includes a piezoelectric ceramic layer 206h, a low impedance backing material layer 208h, a high impedance backing material layer 210h and a matching material layer 216h. Similar to the discussion of the low frequency transducer above, the piezoelectric ceramic layer 2016h for the high frequency transducer is also coupled to electronic circuitry (not shown) that is configured to generate (and/or receive) the beams for the high frequency transducer. Note also that the piezoelectric ceramic layer 206h for the high frequency transducer illustrated in the embodiment of FIG. 4 may further include an aperture 207 in some implementations. The purpose of this aperture 207 in the embodiment illustrated is to ensure that the beam width of the high frequency transducer 202 matches that of the beam width for the low frequency transducer 204 in the illustrated implementation.

FIG. 4 also illustrates a cross-sectional view of the dual frequency piston transducer 200 of FIG. 2. Specifically, as shown in FIG. 4, the depth of transducer face 206l for the low frequency piston transducer is shown to be proportionate to the disparity in resonant frequency between the low 206l and high 206h frequency faces. For example, using the aforementioned resonant frequencies of twelve hundred (1,200) kHz and three hundred (300) kHz, the depth of the low frequency face 206l will be approximately four (4) times as large as the high frequency face 206h. Moreover, the depth of layers 208l, 208h and 210l, 210h are similarly proportionate in size as a function of their disparity in resonant frequency. As a result of these proportionate depths, the beamwidths for these two transducer faces 206l and 206h are approximately equal.

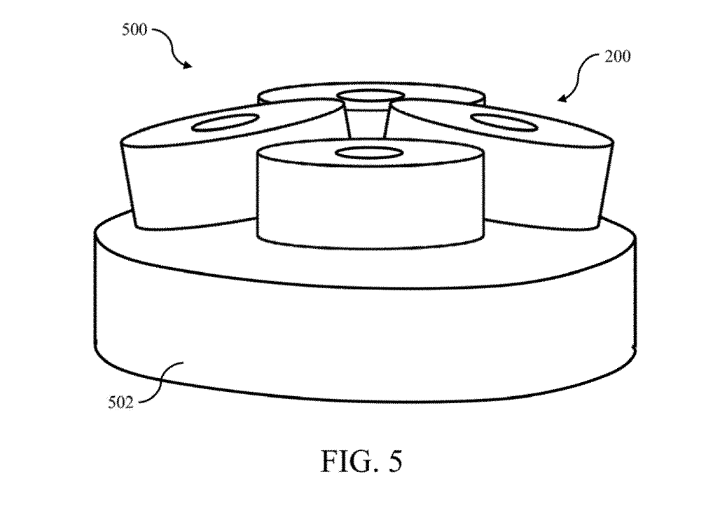

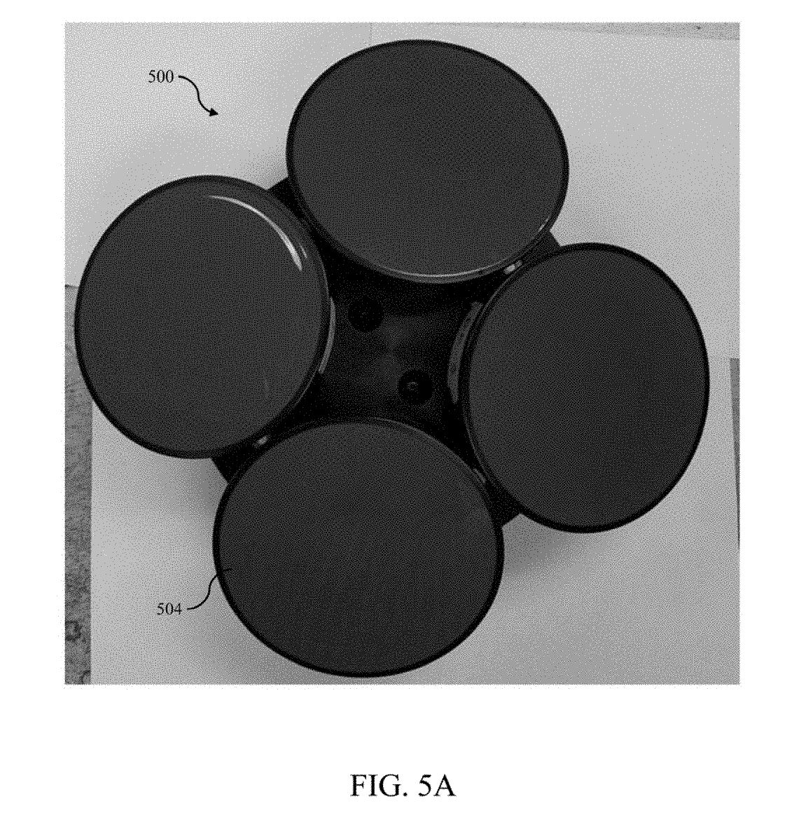

The transducer structure may include a so-called cup 400 which houses the low and high frequency transducers. The cup 400 may be made from a variety of materials including, polymer-based materials, a metal material (whether cast, forged or machined), or any other suitable material for the intended application. FIG. 5 illustrates a variant transducer array 500 which may be suitable for ADCP applications. As illustrated, the transducer array 500 includes four (4) distinct dual frequency piston transducers 200; although, it would be readily appreciated that more (five or more) or less (three or fewer) dual frequency piston transducers may be utilized in alternative variants. Generally speaking, more transducers give you additional data points at a relatively small incremental processing cost. These additional data points may reduce the level of measured error resultant from the measurement. For example, error velocities may be measured using four (4) dual frequency transducers 200; however error velocities may be difficult (or impossible) to determine using three or fewer transducers. Each of the dual frequency piston transducers 200 may be oriented such that each of the dual frequency piston transducers 200 is oriented in a unique direction as compared with other ones of the dual frequency piston transducers 200 (e.g., in a so-called Janus configuration).

The dual frequency piston transducers 200 also advantageously reside in a single housing 502. This housing 502 may constitute a “cup” that may be made from any number of suitable materials including metals, polymers, or combinations of the foregoing. Such a transducer array 500 may permit acoustical radiation patterns based on the excitation of the particular resonance frequency of the piezo-element. Herein lays a salient advantage of the configuration 500 shown in FIG. 5. Namely, the multiple dual frequency piston transducers 200 may be installed into the hull of a surface ship using a single hull penetration making its installation easier and more cost effective than prior installation techniques for ADCP installations. FIG. 5A illustrates a transducer array 500 that includes four of the transducer structures. Note that the illustrated transducer array is arranged in a Janus configuration for use with, for example, ADCP applications. The illustrated transducer array 500 may include a water proofing material 504 (e.g., epoxy resin) that encapsulates the transducers as well as the underlying electronics. In addition to its benefit in water proofing, the water proofing material 504 may provide for an “acoustic window” so that energy may be transferred to/from the transducer into the fluidic medium (e.g., water). The thickness of the water proofing material 504 may be further optimized based on the operating frequency and the size of the transducer itself.

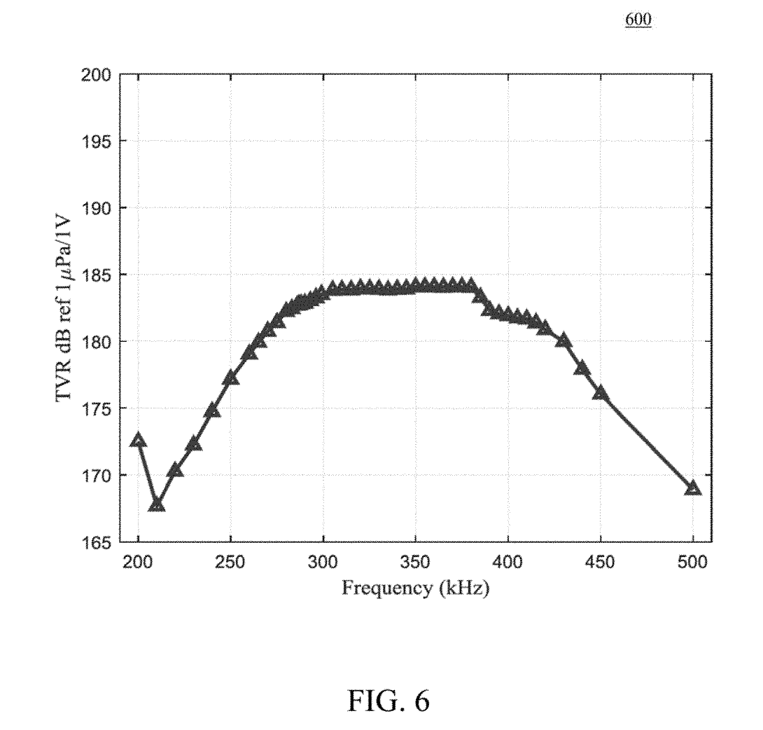

FIG. 6 illustrates the measured transmit voltage response 600 for an exemplary dual frequency transducer 200 in a frequency range from about two hundred (200) kHz up to about five hundred (500) kHz. The illustrated transmit voltage response plots illustrate the bandwidth being over 25% which is an advantage over the dual frequency array illustrated in, for example, co-owned U.S. patent application Ser. No. 13/282,257 filed Oct. 26, 2011 entitled “Multi Frequency 2D Phased Array Transducer”, the contents of which were incorporated supra, which has an achievable bandwidth of approximately 6%.

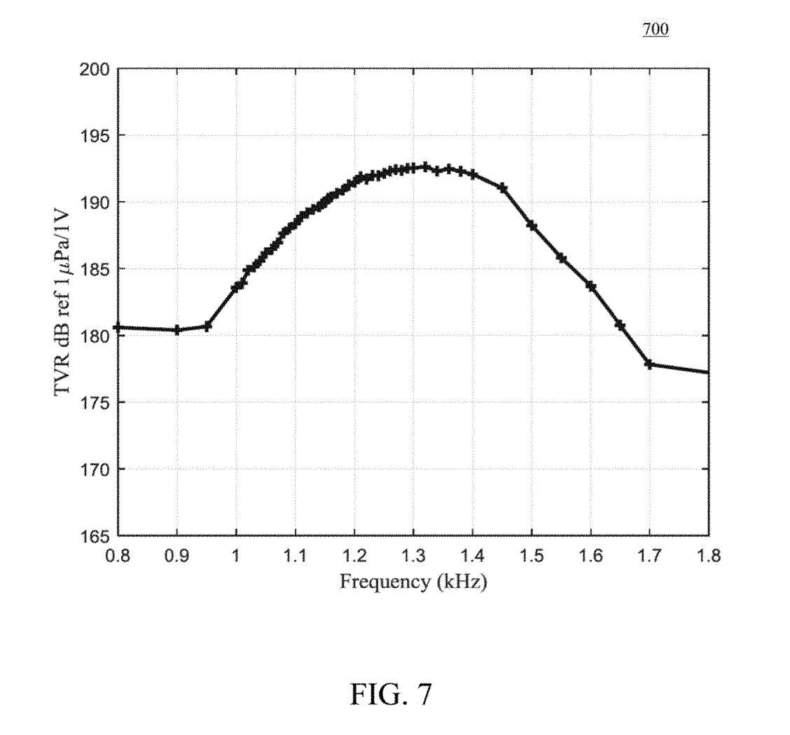

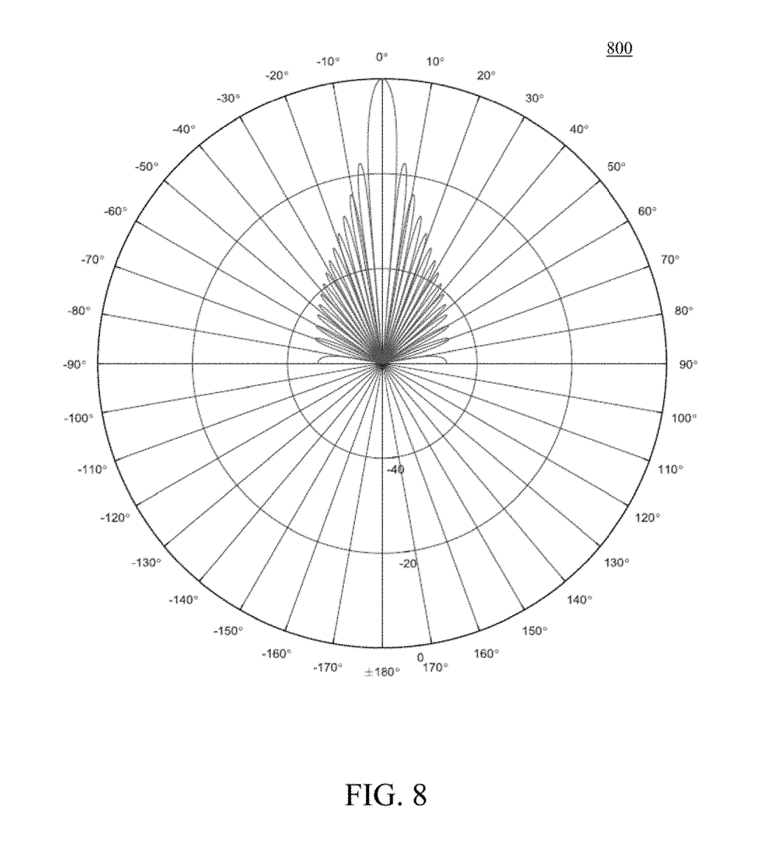

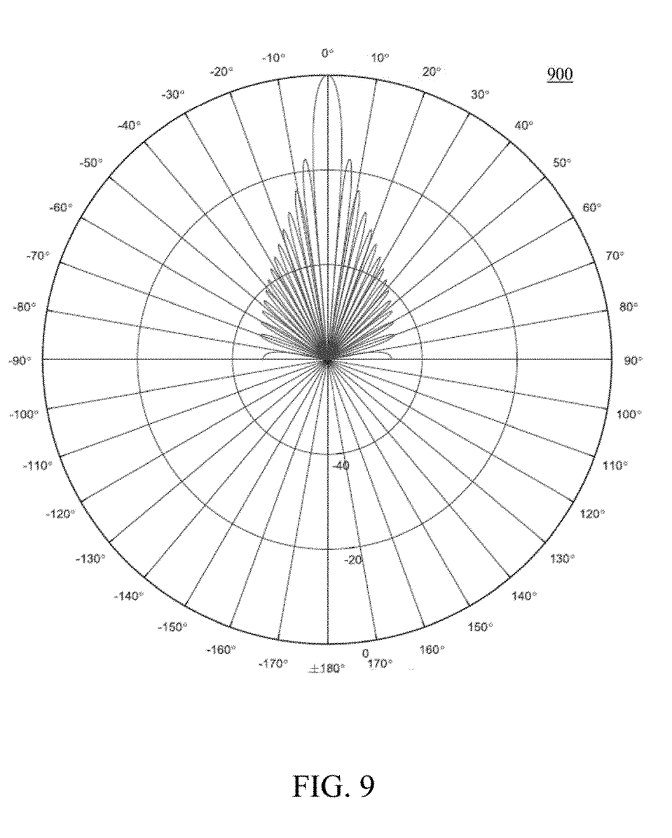

FIG. 7 illustrates the measured transmit voltage response 700 for an exemplary dual frequency transducer 200 in a frequency range from about eight hundred (800) kHz up to about eighteen hundred (1,800) kHz. FIG. 8 illustrates a beam pattern plot 800 for an exemplary high frequency transducer of the exemplary dual frequency transducer 200 shown in FIG. 2, while FIG. 9 illustrates a beam pattern plot 900 for an exemplary low frequency transducer of the exemplary dual frequency transducer 200 shown in FIG. 2. As is illustrated, the beam patterns and the beam widths at both transducer faces are identical (or nearly identical) to one another.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the implementations disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. A broadband electroacoustic transducer for producing sound in a fluid medium, comprising:
a plurality of disk transducer elements, each having different fundamental resonance frequencies with each fundamental resonance frequency having an independent surface area, the different fundamental frequencies being a result of differing dimensions between each of the plurality of disk transducer elements and/or each of the plurality of disk transducer elements having different backing and/or front layers in order to produce surface vibrations to form independent beams.

2. The electroacoustic broadband transducer of claim 1, wherein the plurality of disk transducer elements comprises a first disk transducer element and a second disk transducer element, the second disk transducer element operating at a resonant frequency that is higher than the first disk transducer element, the first disk transducer element and the second disk transducer element having an identical, or near identical, beam width.

3. The electroacoustic broadband transducer of claim 2, wherein the second disk transducer element is positioned within a first aperture of the first disk transducer element and the second disk transducer element including a second aperture that provides for the identical, or near identical, beam width.

4. The electroacoustic broadband transducer of claim 2, wherein the first disk transducer element and the second disk transducer element each comprise a bandwidth of approximately 50%, the bandwidth being 25% above and 25% below the respective fundamental resonant frequencies for the first disk transducer element and the second disk transducer element.

5. The electroacoustic broadband transducer of claim 1, where the plurality of disk transducer elements may be operated at a same resonant frequency in an alternative operating mode.

6. The electroacoustic broadband transducer of claim 1, wherein the plurality of disk transducer elements are aligned axisymmetrically with a height-to-radius aspect ratio less than unity in order to produce acoustic radiation along the direction of the axis of symmetry and simultaneously in the direction perpendicular to the axis of symmetry.

7. The electroacoustic broadband transducer of claim 1, wherein the plurality of disk transducer elements are encapsulated in a cup made of metal or plastic that permits acoustical radiation based on excitation of the respective fundamental resonance frequency of a respective piezoelement.

8. The electroacoustic broadband transducer of claim 2, wherein the second disk transducer element is ¼ of the thickness of the first disk transducer element, the thickness difference contributing to the identical, or near identical, beam width.

9. The electroacoustic broadband transducer of claim 2, wherein the second disk transducer element is utilized for measuring backscattering strength in shallow water or at close ranges, while the first disk transducer element is utilized for measuring backscattering strength at ranges farther away than the second disk transducer element.

10. The electroacoustic broadband transducer of claim 1, wherein the plurality of disk transducer elements are connected electrically to a transmitting device to realize operation as an acoustic source or acoustic receiver, capable of measuring water currents underwater, detecting depth of a given water column, and measuring backscattering signal strength to detect objects underwater.

11. The electroacoustic broadband transducer of claim 2, where the second disk transducer element may be used for measuring underwater water flow speed and direction in shallow water or at close range to the electroacoustic transducer and the first disk transducer element may be used for measuring underwater water flow speed and direction at ranges farther away from the electroacoustic transducer.

12. The electroacoustic transducer of claim 1, wherein each of the plurality of disk transducer elements comprise a piezoelectric disk transducer or using single crystal.

13. The electroacoustic transducer of claim 1, wherein each disk transducer element of the plurality of disk transducer elements may collectively operate in a frequency range that varies from 50 kHz to 3 MHz and operated at a local bandwidth of about 25% of the resonant frequency of operation.

14. The electroacoustic transducer of claim 1, wherein the plurality of disk transducer element may collectively be used as a high power device with half passive materials.

15. The electroacoustic transducer of claim 1, wherein the plurality of disk transducer element may collectively be used as a high power device with half passive materials.

16. A broadband electroacoustic array for producing sound in a fluid medium, comprising:
a plurality of cups, each cup of the plurality comprising:
a plurality of disk transducer elements, each having different fundamental resonance frequencies with each fundamental resonance frequency having an independent surface area, the different fundamental frequencies being a result of differing dimensions between each of the plurality of disk transducer elements and/or each of the plurality of disk transducer elements having different backing and/or front layers in order to produce surface vibrations to form independent beams; and
electronic circuitry that drive each of the plurality of disk transducer elements.

17. The broadband electroacoustic array of claim 16, wherein the plurality of disk transducer elements comprises a first disk transducer element and a second disk transducer element, the second disk transducer element operating at a resonant frequency that is higher than the first disk transducer element, the first disk transducer element and the second disk transducer element having an identical, or near identical, beam width.

18. The broadband electroacoustic array of claim 17, wherein the second disk transducer element is positioned within a first aperture of the first disk transducer element and the second disk transducer element including a second aperture that provides for the identical, or near identical, beam width.

19. The broadband electroacoustic array of claim 18, wherein the first disk transducer element and the second disk transducer element each comprise a bandwidth of approximately 50%, the bandwidth being 25% above and 25% below the respective fundamental resonant frequencies for the first disk transducer element and the second disk transducer element.

20. The broadband electroacoustic array of claim 19, wherein:
the broadband electroacoustic array is configured to be utilized in Acoustic Doppler Current Profiler (ADCP) applications; and
the broadband electroacoustic array may be operated at depths greater than 2000 m for the fluid medium.
